(19) United States
(12) Patent Application Publication
(10) Pub. No.: US 2012/0191620 A1
(43) Pub. Date: Jul. 26, 2012

(54) FACILITATING CONNECTIONS BY ENTREPRENEURS THROUGH A COMPUTER BASED SYSTEM

(75) Inventor: Francisco Javier Codina, Miramar, FL (US)

(73) Assignee: NEURS LLC, Palo Alto, CA (US)

(21) Appl. No.: 13/010,559

(22) Filed: Jan. 20, 2011

(51) Int. Cl. G06Q 99/00

(52) U.S. Cl. 705/319

(57) ABSTRACT

The present invention generally relates to online business networking Specifically, this invention relates to a system and method for facilitating the virtual connection of entrepreneurs with business owners, lenders, service providers, coaches, consultants, investors, and other entrepreneurs through a computer based system that manages the process via the Internet or other network and may be delivered to an end user through static or mobile devices.

### FIELD OF THE INVENTION

The present invention generally relates to online business networking Specifically, this invention relates to a system and method for facilitating the virtual connection of entrepreneurs with business owners, lenders, service providers, coaches, consultants, investors, and other entrepreneurs through a computer based system that manages the process via the Internet or other network and may be delivered to an end user through static or mobile devices.

### BACKGROUND OF THE INVENTION

The world of traditional business networking is changing fast with the increasing popularity of the Internet and use of the World Wide Web. Many of today's leading technology and web based companies are built around solving the need in our society to communicate faster, more efficiently, with people of like minded interest and pursuits. There are virtual marketplaces for artist to showcase their work, freelancers to find work, employees looking for employers and vice versa, people looking for friends, people looking for relationships, and people looking to socially network with others. However, for most entrepreneurs, those looking to start a company or grow their existing business, connecting to the right people that can help them with their specific need seems to be increasingly difficult and for the most part still done in the old fashion way of traditional physical networking events, chamber of commerce meetings, and the occasional unexpected introduction to someone that can be of help in their endeavors.

Alternately, aspiring entrepreneurs could invest significant amounts of time searching online for companies and other entrepreneurs in a vast number of fragmented websites. Many of today's websites focusing on business also attract many looking for jobs or trying to offer employment or products and/or services not applicable to the aspiring entrepreneur or small business owners looking for specific solutions, partners, and business opportunities.

Today's online marketplaces and social networking sites don't provide the most suitable environment for aspiring entrepreneurs, or those desiring to start to grow their small business to meet the right people efficiently. Considering there are thousands of franchise opportunities, hundreds of thousands businesses for sale, and millions of business service providers, coaches, consultants, investors, and other entrepreneurs looking to create business partnerships, an aspiring entrepreneur has to be very lucky to find the right people through today's existing technologies and marketplaces.

Currently, most business networking by entrepreneurs today is still being conducted the way it was 30 years ago. The only major difference is the advantage of being able to send an email and answer a cell phone call as a method of follow up. There is no single place where entrepreneurs can exclusively meet, network, decide to create business connections, have meetings, and even transact payments for basic services like the incorporation of a business, accounting services, coaching and consulting advise, marketing services, and all other type of business transaction specifically needed by entrepreneurs and their solution providers.

Furthermore, business opportunity providers like franchises and direct selling companies do not have a single meeting point where a vast number of entrepreneurial minded individuals exclusively meet. Instead these companies try traditional marketing and advertizing techniques hoping to find the right person out of the thousands of people that will view their ads. Direct selling companies, that by definition, do not conduct any form of advertizing, still find and attract to their businesses the more than 16 million current distributors, having increased that figure by 1 million in 2009 alone. Almost 100% done the old fashion way of word of mouth; people telling people. In those types of businesses, often times timing is everything. Getting in at the right time and being first in a market can make a huge difference to an aspiring entrepreneur. If those potential distributor or franchises are not reached using these traditional techniques, there's an opportunity cost to both the opportunity provider and aspiring entrepreneur. Many distributors or franchises will never hear about a new business or rapidly growing opportunity in their area, simply because no one in their immediate circle of friends and colleagues knew about this opportunities, and so on.

As a result, these traditional methods, both online and offline, of business networking, is highly fragmented and comparing business opportunities, meeting with business opportunity and services providers has traditionally been a time-consuming, and highly inefficient, costly endeavor for both aspiring entrepreneurs and business opportunity and service providers since this single meeting point does not exist.

Therefore, there is a need in the art for a system and method for improving business networking by providing a single online platform for the creation of business connections. These and other features and advantages of the present invention will be explained and will become obvious to one skilled in the art through the summary of the invention that follows.

### SUMMARY OF THE INVENTION

The present invention provides entrepreneurs and business opportunity and service providers a single networked platform for the creation of business connections. The platform uniquely combines a mechanism by which all members can create electronic posts either offering their opportunities or services or requesting help regarding the specific need they may have as an aspiring entrepreneur or business owner trying to grow their business.

According to embodiments of the present invention, a searchable database of offers and requests is provided, allowing members to send or request proposals from a posting. Upon receiving a proposal, the member that created the post may decide to create a connection with the member that sent the proposal or decline the proposal. If the connection is made, the members may then enter a virtual meeting room where they can discuss specific terms of their meeting arrangement.

According to an embodiment of the present invention, an agreement area allows for crafting, submission, and approval by two or more members of contracts and agreements for one or more of a business service, transaction, opportunity, and/or strategy alliance.

According to an embodiment of the present invention, once an agreement has been reached by the two or more members, a payment center may be activated and one or more transactions using credit, debit and a variety of virtual payment solutions may be generated and confirmed without leaving the area where a proposal was first sent.

According to an embodiment of the present invention, a member using a GPS enabled computing device, could search an offers and requests database for those that are within a certain distance chosen by the member. Upon selecting a request or offer that seems of interest to the member, a profile of the member that created the post may appear. The profile may be comprised of detailed information regarding the request or offer. The member could then approach the member that posted the request or offer knowing exactly what they need or are offering in regards to business opportunities and/or services and a potential live connection is achieved.

According to an embodiment of the present invention, two or more members, upon successfully making a connection and an agreement, either through the use of a computing device or a GPS enabled computing device, may decide to transact a non-monetary exchange where by one or more members receives something of value form the one or more other members and vice versa. An example of this would be a coach or consultant that would provide their expertise in exchange for a business owner or entrepreneur to provide connections or referrals to the coach or consultant.

Embodiments of the present invention are mechanisms conceived to link businesses and individuals in a manner destined to revolutionize and achieve growth and productivity in the global marketplace. One of the goals of the invention is to identify and pair up businesses and/or individuals that will benefit from their synergistic alliances to achieve their maximum growth potential and productivity.

### BRIEF DESCRIPTION OF THE DRAWINGS

FIG. 1 is a schematic overview of a network system for carrying out this invention in accordance with an embodiment of the present invention;

FIG. 2 is a flowchart describing a procedure for creating a offer post and the steps involved in creating connections in accordance with an embodiment of the present invention;

FIG. 3 is a flowchart describing a procedure for creating a request post and the steps involved in creating connections in accordance with an embodiment of the present invention;

FIG. 4 is a flowchart describing a procedure for searching for an offer post and the steps involved in creating connections in accordance with an embodiment of the present invention;

FIG. 5 is a flowchart describing a procedure for searching for an request post and the steps involved in creating connections in accordance with an embodiment of the present invention;

FIG. 6 is a screen shot of an exemplary embodiment of a create post procedure;

FIG. 7 is a screen shot of an exemplary embodiment of an offers search function;

FIG. 8 is a flowchart of search filters that may be applied to narrow a search for desired offers or requests in accordance with an embodiment of the present invention;

FIG. 9 is a screen shot of an exemplary embodiment of a proposal request process;

FIG. 10 is a screen shot of an exemplary embodiment of a requests search function;

FIG. 11 is a screen shot of an exemplary embodiment of a proposal sending process;

FIG. 12 is a screen shot of an exemplary embodiment of a proposal review process;

FIG. 13 is a screen shot of an exemplary embodiment of a proposal reviewing process;

FIG. 14 is a screen shot of an exemplary embodiment of meeting room functions;

FIG. 15 is a screen shot of an exemplary embodiment of agreement tab functions;

FIG. 16 is a screen shot of an example of the payment tab functions;

### DETAILED SPECIFICATION

The present invention generally relates to online business networking Specifically, this invention relates to a system and method for facilitating the virtual connection of entrepreneurs with business owners, lenders, service providers, coaches, consultants, investors, and other entrepreneurs through a computer based system that manages the process via the Internet or other network and may be delivered to an end user through static or mobile devices.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

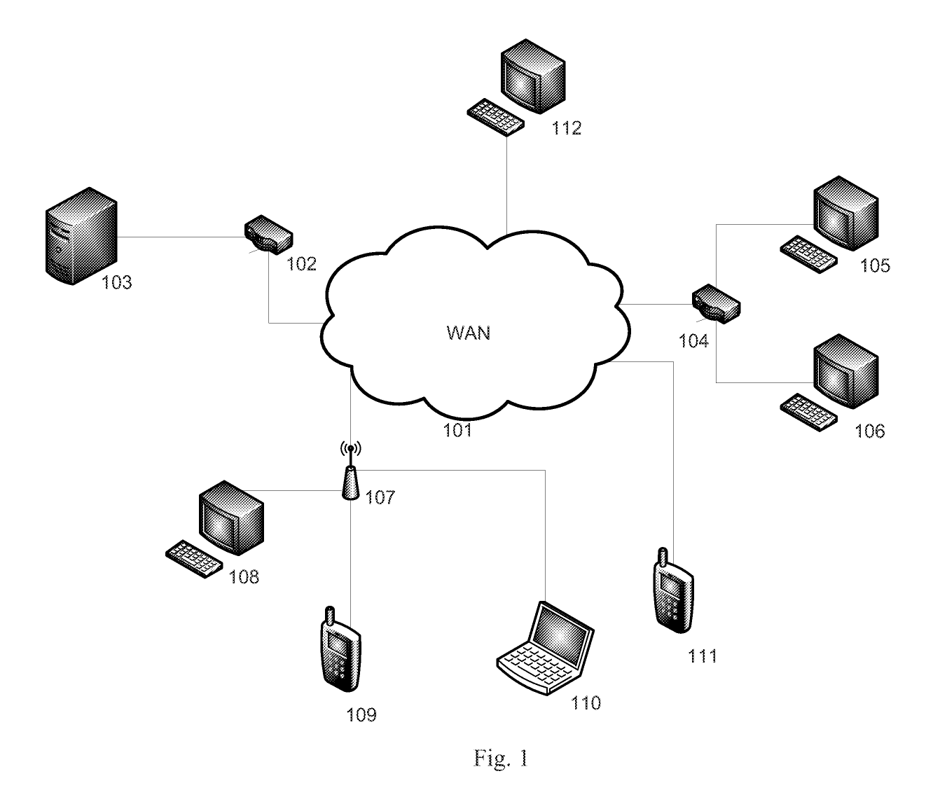

Referring to FIG. 1, a schematic overview of a system in accordance with an embodiment of the present invention is shown. The system is comprised of one or more application servers 103 for electronically storing information used by the system. Applications in the server 103 may retrieve and manipulate information in storage devices and exchange information through a WAN 101 (e.g., the Internet).

According to an exemplary embodiment, as shown in FIG. 1, exchange of information through the WAN 101 or other network may occur through one or more high speed connections directed through one or more routers 102. Router(s) 102 are completely optional and other embodiments in accordance with the present invention may or may not utilize one or more routers 102. One of ordinary skill in the art would appreciate that there are numerous ways server 103 may connect to WAN 101 for the exchange of information, and embodiments of the present invention are contemplated for use with any method for connecting to networks for the purpose of exchanging information.

Members may connect to server 103 via WAN 101 or other network in numerous ways. For instance, a Member may connect to the system i) through a computing device 112 directly connected to the WAN 101, ii) through a computing device 105, 106 connected to the WAN 101 through a routing device 104, iii) through a computing device 108, 109, 110 connected to a wireless access point 107 or iv) through a computing device 111 via a wireless connection (e.g., CDMA, GMS, 3G, 4G) to the WAN 101. One of ordinary skill in the art would appreciate that there are numerous ways that a member may connect to Server 103 via WAN 101 or other network, and embodiments of the present invention are contemplated for use with any method for connecting to Server 103 via WAN 101 or other network.

According to an embodiment of the present invention, an individual or organization may signup to become a member of the system herein provided. In an exemplary embodiment, an individual or organization would go through a registration process, whereby they would provide identifying information to be stored in application server 103. This identifying information may be used, for instance, to identify the user, secure their login or process financial transactions. One of ordinary skill in the art would appreciate there are numerous ways to provide and manage registration processes, and embodiments of the present invention are contemplated for use with any method for providing and managing registration processes.

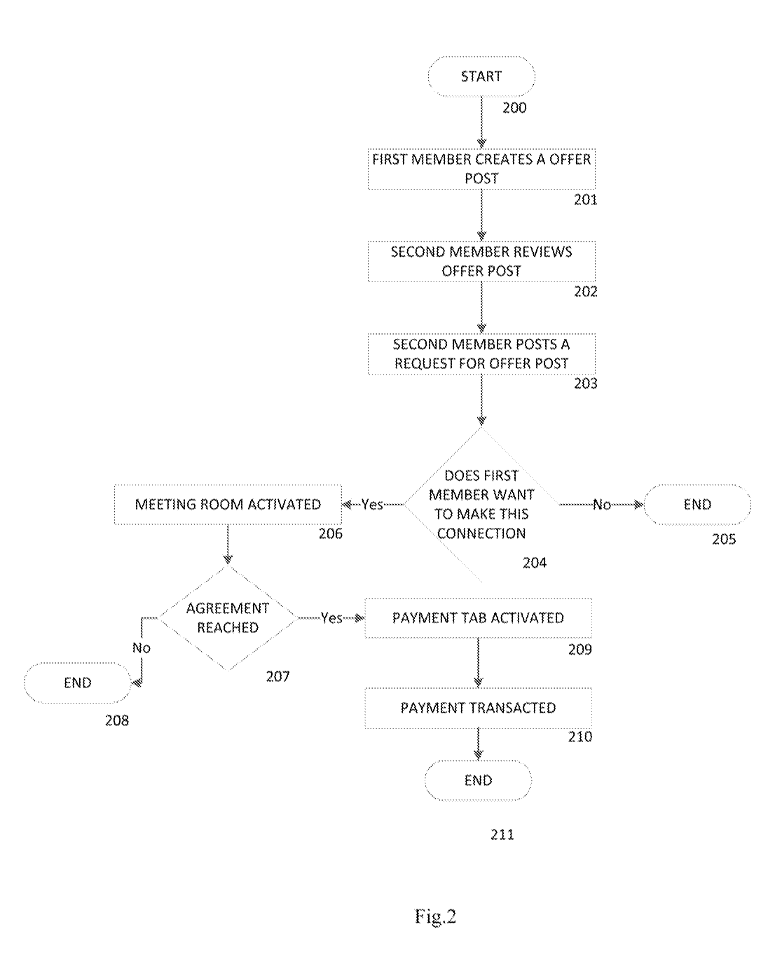

Turning now to FIG. 2, an exemplary embodiment of the offer post methodology, in accordance with an embodiment of the present invention, is described. This process may be provided to one or more members using the application server 103, through the member's computing device(s).

The method starts at step 200 by a first member when they login to the application server 103 through the WAN 101 and consequently click on the CONNECTIONS tab of a provided webpage.

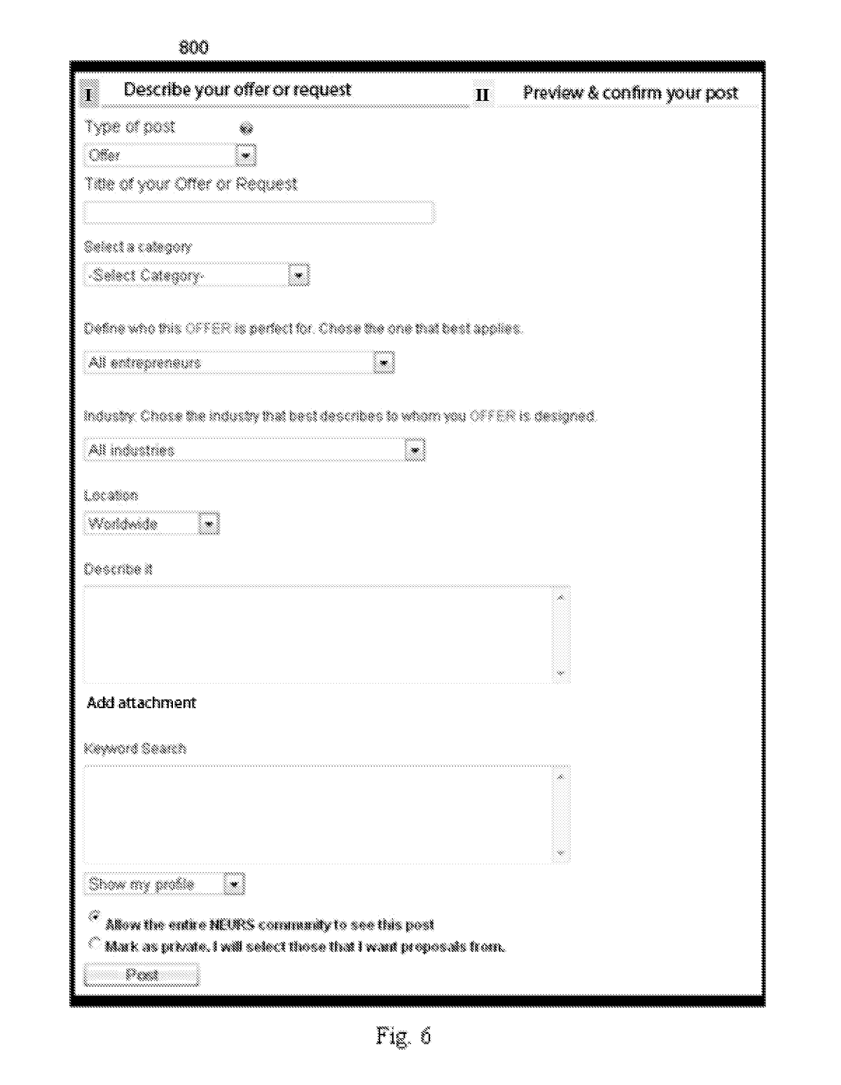

At step 201, the first member decides to post an offer. An offer may be comprised of one or more of an offer to provide services, sell goods or strategically ally with other members. One of ordinary skill in the art would appreciate that there are numerous types of offers that could be made, and embodiments of the present invention are contemplated for use of any type of offer. The details of what is required to create a post, in accordance with an exemplary embodiment of the present invention, are explained in FIG. 6.

At step 202, a second member receives and reviews the offer post. According to an exemplary embodiment, the second member will only receive the offer post if he/she/it fits one or more criteria placed upon the offer post by the first member. For instance, a offer post looking for a strategic alliance between a first member who is a manufacturer and a yet to be indentified second member who is in the business of distribution could be sent only to members who are in the business of distribution.

Furthermore, according to an embodiment of the system in accordance with the present invention, the second member may be alerted to the receipt of the offer post in a variety of manners. Methods in which the second member may be alerted include, but are not limited to, SMS, e-mail, facsimile, phone call and/or notification when the second member logs into the system. One of ordinary skill in the art would appreciate that there are numerous ways to alert a member, and embodiments of the present invention are contemplated for use with any manner of alerting members.

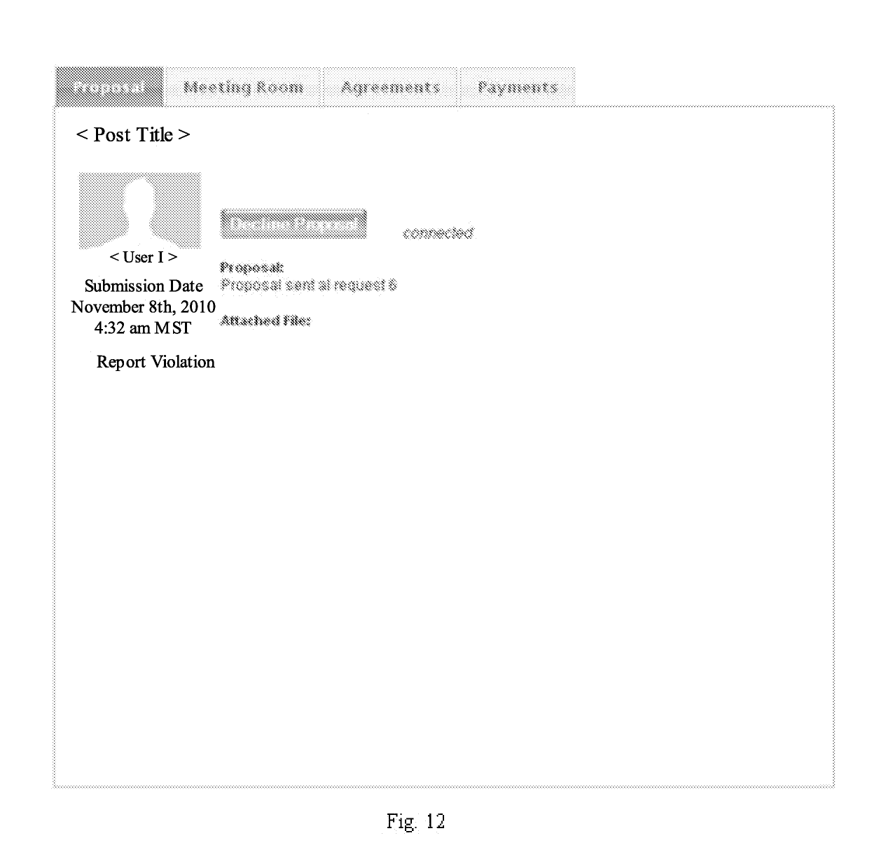

At step 203, a second member makes a request post for the offer post made by the first member. Details of the functions of the request post, in accordance with an exemplary embodiment of the present invention, are explained in FIG. 12. The request post may include a plurality of data points that may be pertinent to the first member, the offer post or both. Data points include, but are not limited to, the name and location of the second member, financial data regarding the second member, financial data regarding the offer post or the request post and second member contact information. One of ordinary skill in the art would appreciate that there are numerous data points that may be pertinent to include in the request post, and embodiments of the present invention are contemplated for use with any number of data points.

At step 204 the first member decides whether to accept the second member's request post and the second member as a connection or decline the request post. If the second member's request post is declined, the process ends at step 205.

Alternately, at step 206 the first member accepts the request post from the second member and adds the second member as a connection.

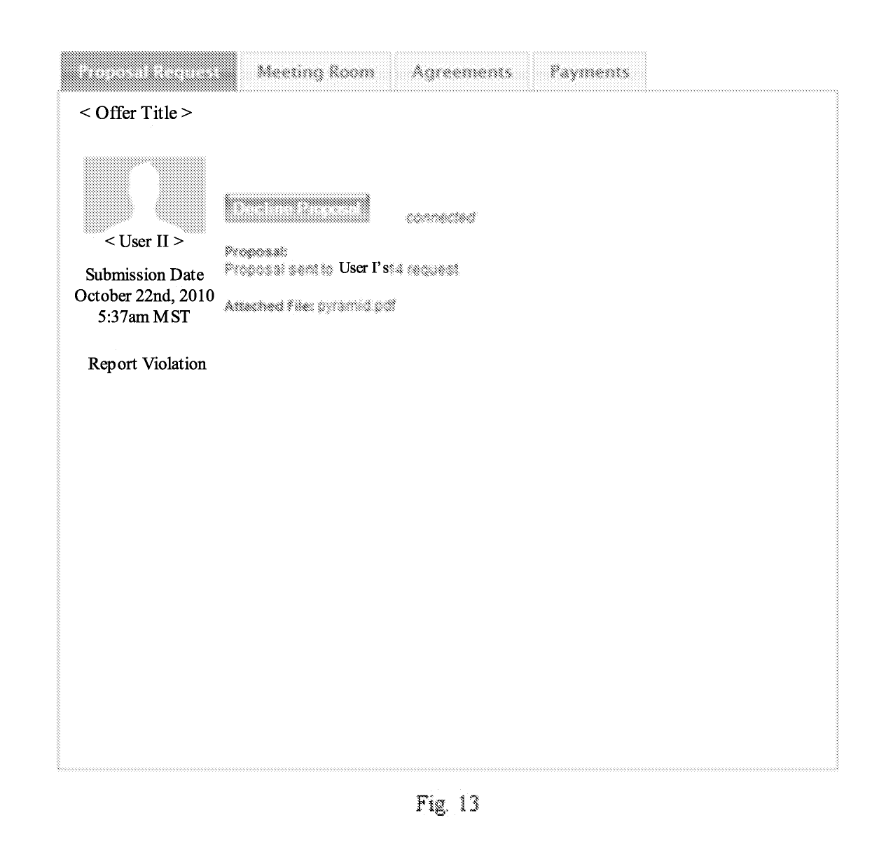

At step 206 a meeting room is also activated. Details of the meeting room, in accordance with an exemplary embodiment of the present invention, are explained in FIG. 13. At this step the first member and the second member may communicate using the meeting room functions described below.

Optionally, the first member, who initially sent the offer post, may accept the proposals of more than one other member. In this manner, offer post may be utilized by a plurality of members, each able to serve and/or receive services and/or goods from the conglomerated union.

At step 207, the first member and the second member may decide to enter into an agreement in regards to the offer post. Only if both the first member and the second member agree on the terms of the agreement, the payment tab is activated. Agreements may be made in any number of manners. Agreements may include, but are not limited to, exchange of services for monetary sums, exchange of services for non-monetary sum, exchange of services for services, exchange of goods for non-monetary sums, exchange of goods for services, exchange of goods for goods, exchange of goods for monetary sums and any combination thereof. One of ordinary skill in the art would appreciate that there are numerous types of agreements that may be formed through embodiments of the present invention, and embodiments of the present invention are contemplated for use with any type of agreement.

At step 208, assuming that the agreement was not reached, the process ends.

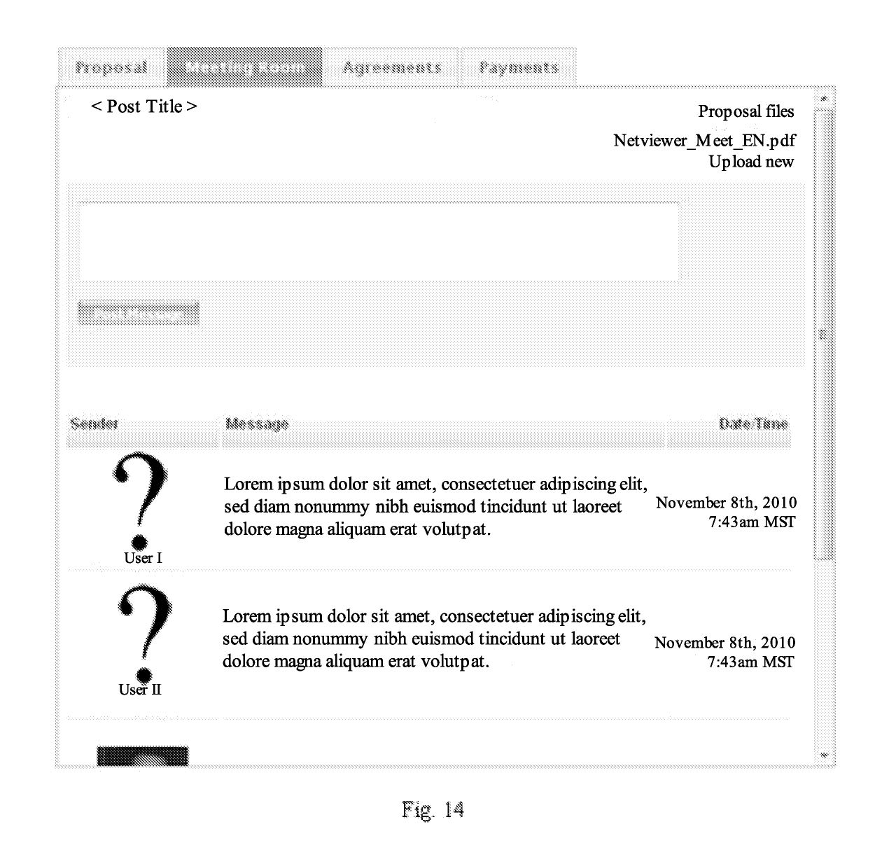

At step 209, the payment tab is activated. Details of the functions of the agreement tab, in accordance with an exemplary embodiment of the present invention, are explained in FIG. 14.

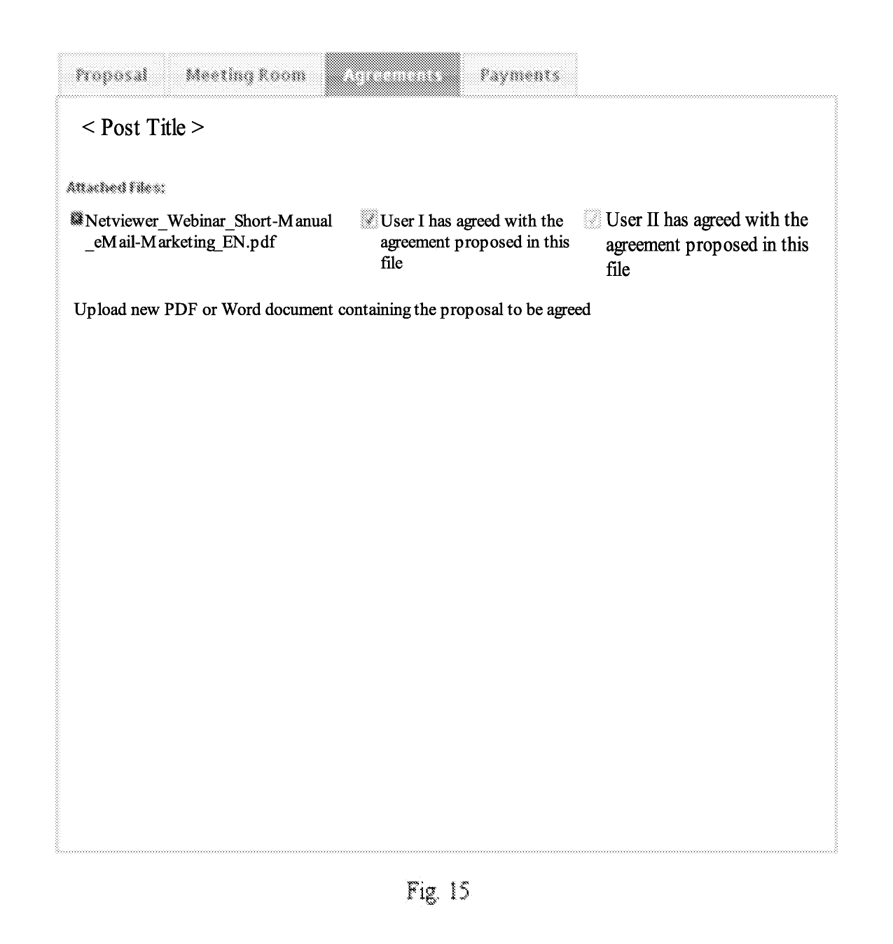

At step 210, the transaction takes place and the funds are withdrawn from an account belonging to the second member and credited to an account belonging to the first member. Details of the functions of the payment tab, in accordance with an exemplary embodiment of the present invention are explained in FIG. 15.

At step 211, assuming that the agreement and subsequent payment were transacted, the process ends.

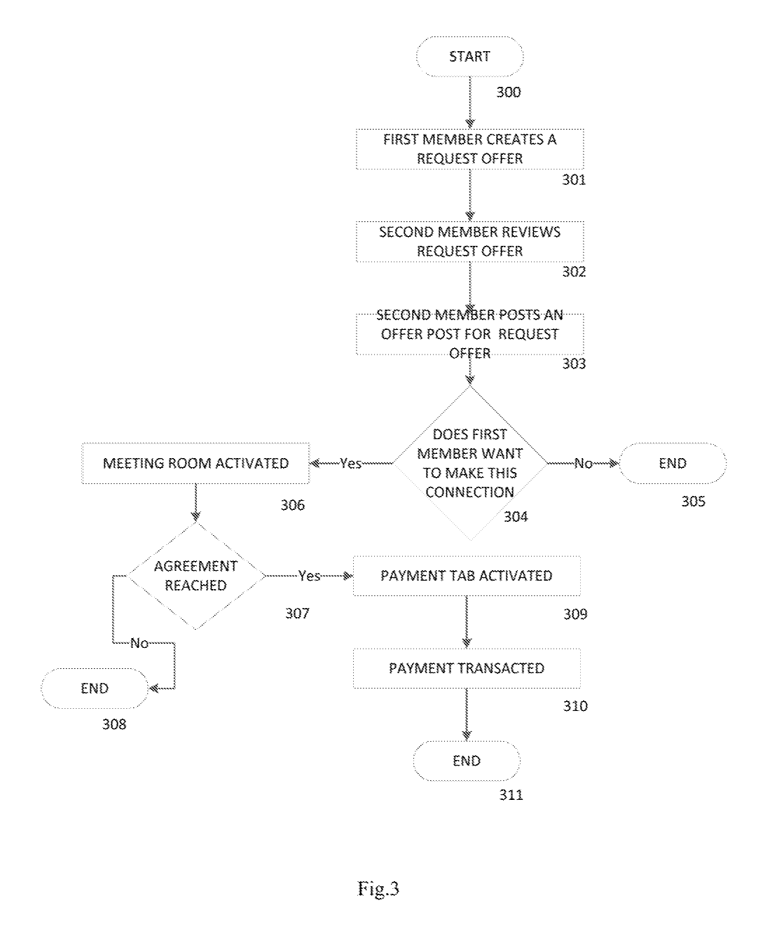

Turning now to FIG. 3, an exemplary embodiment of the request post methodology, in accordance with an embodiment of the present invention, is described. This process may be provided to one or more members using the application server 103, through the member's computing device(s).

The method starts at step 300 by a first member when they login to the application server 103 through the WAN 101 and consequently click on the CONNECTIONS tab of a provided webpage.

At step 301, the first member decides to post an request. A request may be comprised of one or more of an request to receive services, purchase or lease goods or strategically ally with other members. One of ordinary skill in the art would appreciate that there are numerous types of requests that could be made, and embodiments of the present invention are contemplated for use of any type of request. The details of what is required to create a post, in accordance with an exemplary embodiment of the present invention, are explained in FIG. 6.

At step 302, a second member receives and reviews the request post. According to an exemplary embodiment, the second member will only receive the request post if he/she/it fits one or more criteria placed upon the request post by the first member. For instance, a request post from a first member looking for venture capital funding could be sent only to members who are in the business of providing venture capital.

Furthermore, according to an embodiment of the system in accordance with the present invention, the second member may be alerted to the receipt of the request post in a variety of manners. Methods in which the second member may be alerted include, but are not limited to, SMS, e-mail, facsimile, phone call and/or notification when the second member logs into the system. One of ordinary skill in the art would appreciate that there are numerous ways to alert a member, and embodiments of the present invention are contemplated for use with any manner of alerting members.

At step 303, a second member makes an offer post for the request post made by the first member. Details of the functions of the offer post, in accordance with an exemplary embodiment of the present invention, are explained in FIG. 12. The offer post may include a plurality of data points that may be pertinent to the first member, the offer post or both. Data points include, but are not limited to, the name and location of the second member, financial data regarding the second member, financial data regarding the request post or the offer post and second member contact information. One of ordinary skill in the art would appreciate that there are numerous data points that may be pertinent to include in the offer post, and embodiments of the present invention are contemplated for use with any number of data points.

At step 304 the first member decides whether to accept the second member's offer post and the second member as a connection or decline the offer post. If the second member's offer post is declined, the process ends at step 305.

Alternately, at step 306 the first member accepts the offer post from the second member and adds the second member as a connection.

At step 306 a meeting room is also activated. Details of the meeting room, in accordance with an exemplary embodiment of the present invention, are explained in FIG. 13. At this step the first member and the second member may communicate using the meeting room functions described below.

Optionally, the first member, who initially sent the request post, may accept the proposals of more than one other member. In this manner, request post may be utilized by a plurality of members, each able to serve and/or receive services and/or goods from the conglomerated union.

At step 307, the first member and the second member may decide to enter into an agreement in regards to the request post. Only if both the first member and the second member agree on the terms of the agreement, the payment tab is activated. As previously described herein, the agreement may be one of any number of types of agreements.

At step 308, assuming that the agreement was not reached, the process ends.

At step 309, the payment tab is activated. Details of the functions of the agreement tab, in accordance with an exemplary embodiment of the present invention, are explained in FIG. 14.

At step 310, the transaction takes place and the funds are withdrawn from an account belonging to the first member and credited to an account belonging to the second member. Details of the functions of the payment tab, in accordance with an exemplary embodiment of the present invention are explained in FIG. 15.

At step 311, assuming that the agreement and subsequent payment were transacted, the process ends.

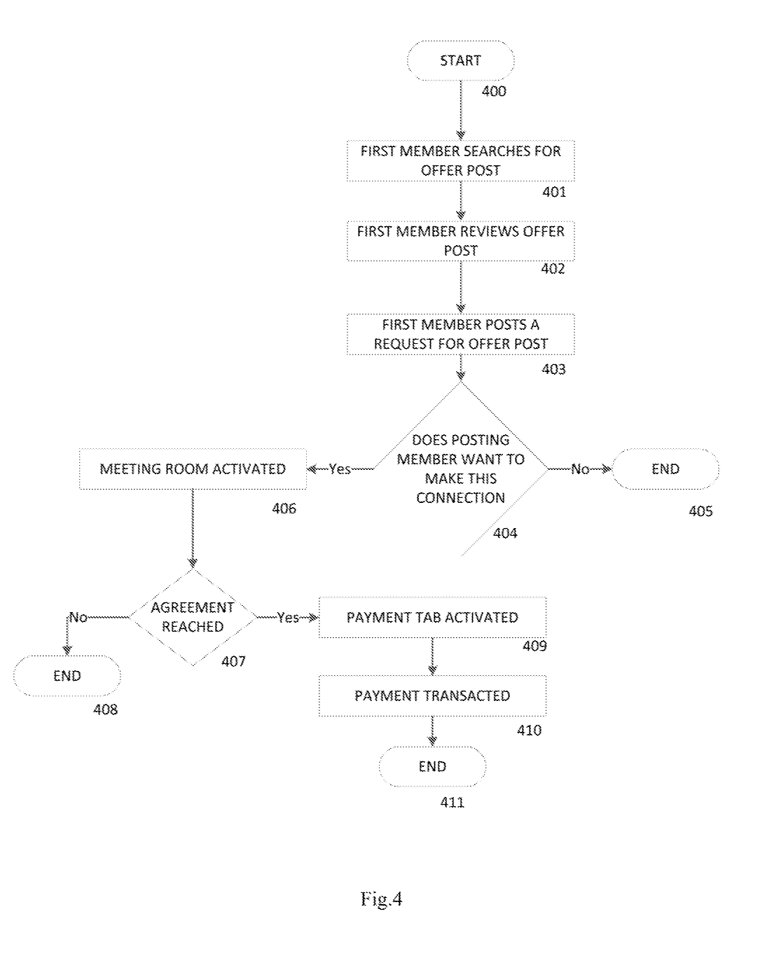

Turning now to FIG. 4, an exemplary embodiment of offer search methodology, in accordance with an embodiment of the present invention, is described. This process may be provided to one or more members using the application server 103, through the member's computing device(s).

The method starts at step 400 by a first member when they login to the application server 103 through the WAN 101 and consequently click on the CONNECTIONS tab of a provided webpage.

At step 401, the first member decides to search for one or more offer posts. An offer may be comprised of one or more of an offer to provide services, sell or lease goods or strategically ally with other members. One of ordinary skill in the art would appreciate that there are numerous types of offers that could be made, and embodiments of the present invention are contemplated for use of any type of request. The details of what is required to create a post, in accordance with an exemplary embodiment of the present invention, are explained in FIG. 6.

At step 402, the first member receives and is able to review one or more offer posts received from application server 103. According to an exemplary embodiment, the first member may only receive the offer post if he/she/it fits one or more criteria placed upon the offer post by a posting member. For instance, an offer post from the posting member looking for venture capital funding could be received only by first members who are in the business of providing venture capital.

Furthermore, according to an embodiment of the system in accordance with the present invention, the first member may be alerted to the receipt of one or more offer posts in a variety of manners. Methods in which the first member may be alerted include, but are not limited to, SMS, e-mail, facsimile, phone call and/or notification when the first member logs into the system. One of ordinary skill in the art would appreciate that there are numerous ways to alert a member, and embodiments of the present invention are contemplated for use with any manner of alerting members.

At step 403, the first member makes a request post for the offer post made by the posting member. Details of the functions of the request post, in accordance with an exemplary embodiment of the present invention, are explained in FIG. 12. The request post may include a plurality of data points that may be pertinent to the posting member, the request post or both. Data points include, but are not limited to, the name and location of the first member, financial data regarding the posting member, financial data regarding the offer post or the request post and first member contact information. One of ordinary skill in the art would appreciate that there are numerous data points that may be pertinent to include in the request post, and embodiments of the present invention are contemplated for use with any number of data points.

At step 404 the posting member decides whether to accept the first member's request post and the first member as a connection or decline the request post. If the first member's request post is declined, the process ends at step 405.

Alternately, at step 406 the posting member accepts the request post from the first member and adds the first member as a connection.

At step 406 a meeting room is also activated. Details of the meeting room, in accordance with an exemplary embodiment of the present invention, are explained in FIG. 13. At this step the first member and the posting member may communicate using the meeting room functions described below.

Optionally, the posting member, who initially sent the offer post, may accept the proposals of more than one other member. In this manner, offer post may be utilized by a plurality of members, each able to serve and/or receive services and/or goods from the conglomerated union.

At step 407, the first member and the posting member may decide to enter into an agreement in regards to the offer post. Only if both the first member and the posting member agree on the terms of the agreement is the payment tab is activated. As previously described herein, the agreement may be one of any number of types of agreements.

At step 408, assuming that the agreement was not reached, the process ends.

At step 409, the payment tab is activated. Details of the functions of the agreement tab, in accordance with an exemplary embodiment of the present invention, are explained in FIG. 14.

At step 410, the transaction takes place and the funds are withdrawn from an account belonging to the first member and credited to an account belonging to the posting member. Details of the functions of the payment tab, in accordance with an exemplary embodiment of the present invention are explained in FIG. 15.

At step 411, assuming that the agreement and subsequent payment were transacted, the process ends.

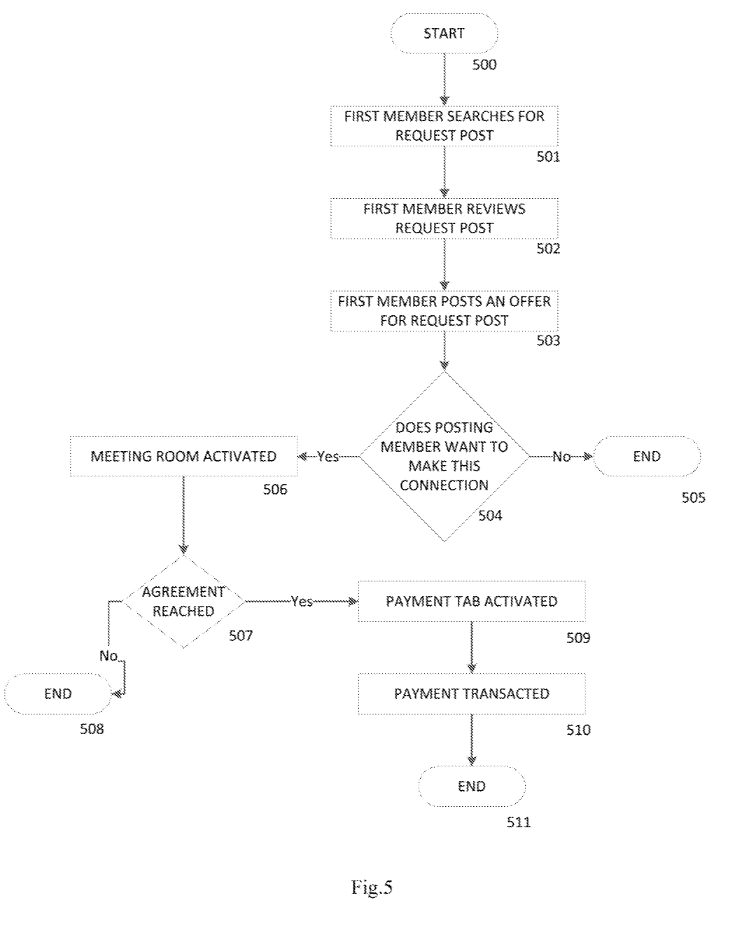

Turning now to FIG. 5, an exemplary embodiment of request search methodology, in accordance with an embodiment of the present invention, is described. This process may be provided to one or more members using the application server 103, through the member's computing device(s).

The method starts at step 500 by a first member when they login to the application server 103 through the WAN 101 and consequently click on the CONNECTIONS tab of a provided webpage.

At step 501, the first member decides to search for one or more request posts. A request may be comprised of one or more of an request to receive services, purchase or lease goods or strategically ally with other members. One of ordinary skill in the art would appreciate that there are numerous types of requests that could be made, and embodiments of the present invention are contemplated for use of any type of request. The details of what is required to create a post, in accordance with an exemplary embodiment of the present invention, are explained in FIG. 6.

At step 502, the first member is able to review one or more request posts received from application server 103. According to an exemplary embodiment, the first member will only receive the request post if he/she/it fits one or more criteria placed upon the request post by a posting member. For instance, a request post from a posting member looking for venture capital funding could be sent only to members who are in the business of providing venture capital.

Furthermore, according to an embodiment of the system in accordance with the present invention, the first member may be alerted to the receipt of one or more request posts in a variety of manners. Methods in which the second member may be alerted include, but are not limited to, SMS, e-mail, facsimile, phone call and/or notification when the second member logs into the system. One of ordinary skill in the art would appreciate that there are numerous ways to alert a member, and embodiments of the present invention are contemplated for use with any manner of alerting members.

At step 503, the first member makes an offer post for the request post made by the posting member. Details of the functions of the offer post, in accordance with an exemplary embodiment of the present invention, are explained in FIG. 12. The offer post may include a plurality of data points that may be pertinent to the first member, the offer post or both. Data points include, but are not limited to, the name and location of the first member, financial data regarding the first member, financial data regarding the request post or the offer post and first member contact information. One of ordinary skill in the art would appreciate that there are numerous data points that may be pertinent to include in the offer post, and embodiments of the present invention are contemplated for use with any number of data points.

At step 504 the posting member decides whether to accept the first member's offer post and the first member as a connection or decline the offer post. If the first member's offer post is declined, the process ends at step 505.

Alternately, at step 506 the posting member accepts the offer post from the first member and adds the first member as a connection.

At step 506 a meeting room is also activated. Details of the meeting room, in accordance with an exemplary embodiment of the present invention, are explained in FIG. 13. At this step the first member and the posting member may communicate using the meeting room functions described below.

Optionally, the posting member, who initially sent the request post, may accept the proposals of more than one other member. In this manner, request post may be utilized by a plurality of members, each able to serve and/or receive services and/or goods from the conglomerated union.

At step 507, the first member and the posting member may decide to enter into an agreement in regards to the request post. Only if both the first member and the posting member agree on the terms of the agreement is the payment tab is activated. As previously described herein, the agreement may be one of any number of types of agreements.

At step 508, assuming that the agreement was not reached, the process ends.

At step 509, the payment tab is activated. Details of the functions of the agreement tab, in accordance with an exemplary embodiment of the present invention, are explained in FIG. 14.

At step 510, the transaction takes place and the funds are withdrawn from an account belonging to the first member and credited to an account belonging to the posting member. Details of the functions of the payment tab, in accordance with an exemplary embodiment of the present invention are explained in FIG. 15.

At step 511, assuming that the agreement and subsequent payment were transacted, the process ends.

Turning now to FIG. 6, in accordance with an exemplary embodiment of the present invention, a form required to create a post on the application server 103 is shown. After deciding which type of post a member wants to create (e.g., an offer post, a request post), a title would be required. This is followed by a category selection of the type of offer or request the member is making The categories may include, but are not limited to, selling a business, coaching and consulting services. One of ordinary skill in the art would appreciate that there are numerous categories that may be used to identify the type of offer or request a member is making, and embodiments of the present invention are contemplated for use with any type of category.

The next required range, as shown in FIG. 6, could be left on the defaulted “All entrepreneurs” or further defined to specifically identify the target market intended for this post. The same holds true for the industry and location; whereby the defaulted “ALL” would be selected unless the member further specifies the industry and intended location of the offer or request.

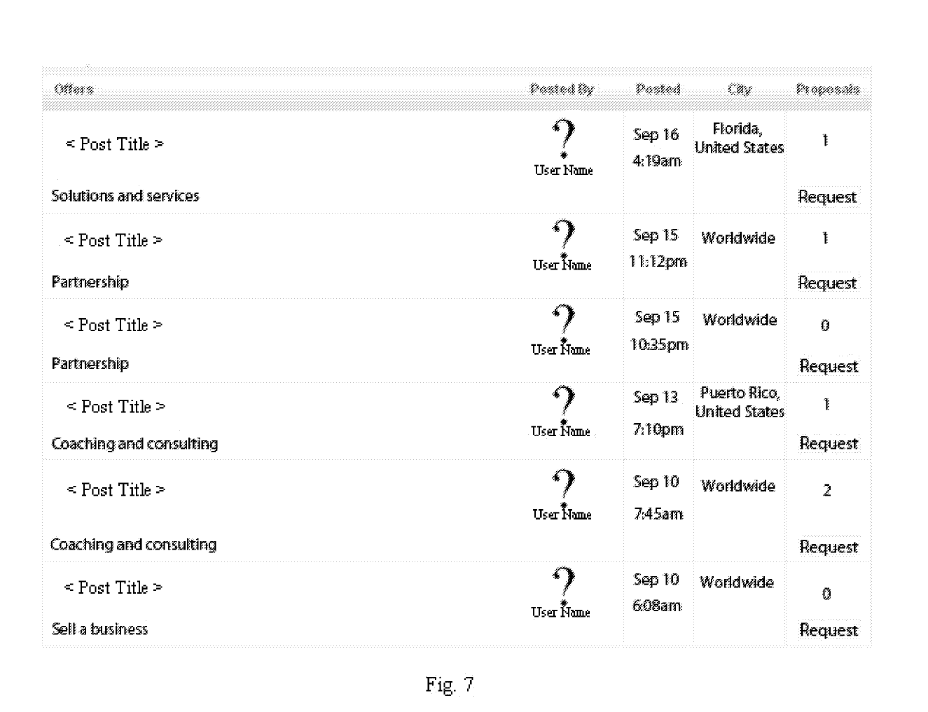

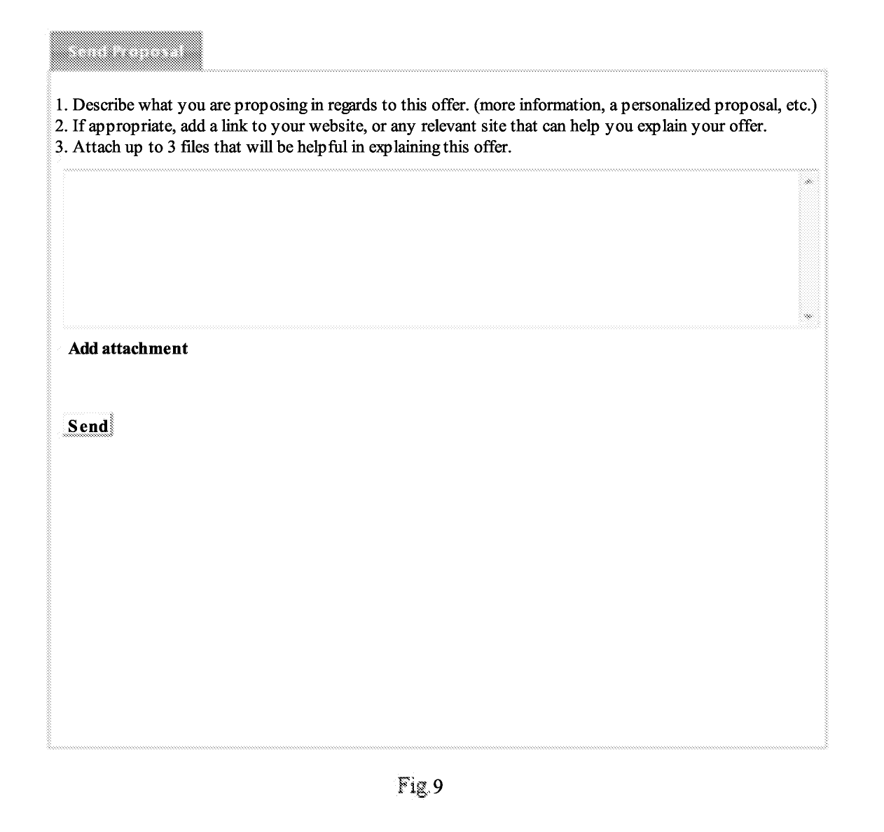

Turning now to FIG. 7, in accordance with an exemplary embodiment of the present invention, an example of the search engine showing offers sorted by posted date and time, as provided by application server 103, is shown. The member may scroll and see all the postings showing the offers. Clicking on any of the postings may allow the member to see detailed information, or sort the posts by alphabetically by title, name of a member that created the offer, date and time posted, intended location, and how many proposals each post has received. The member can also click on the Request button to be taken to the page where a Request Proposal is provided, as further explained in FIG. 9.

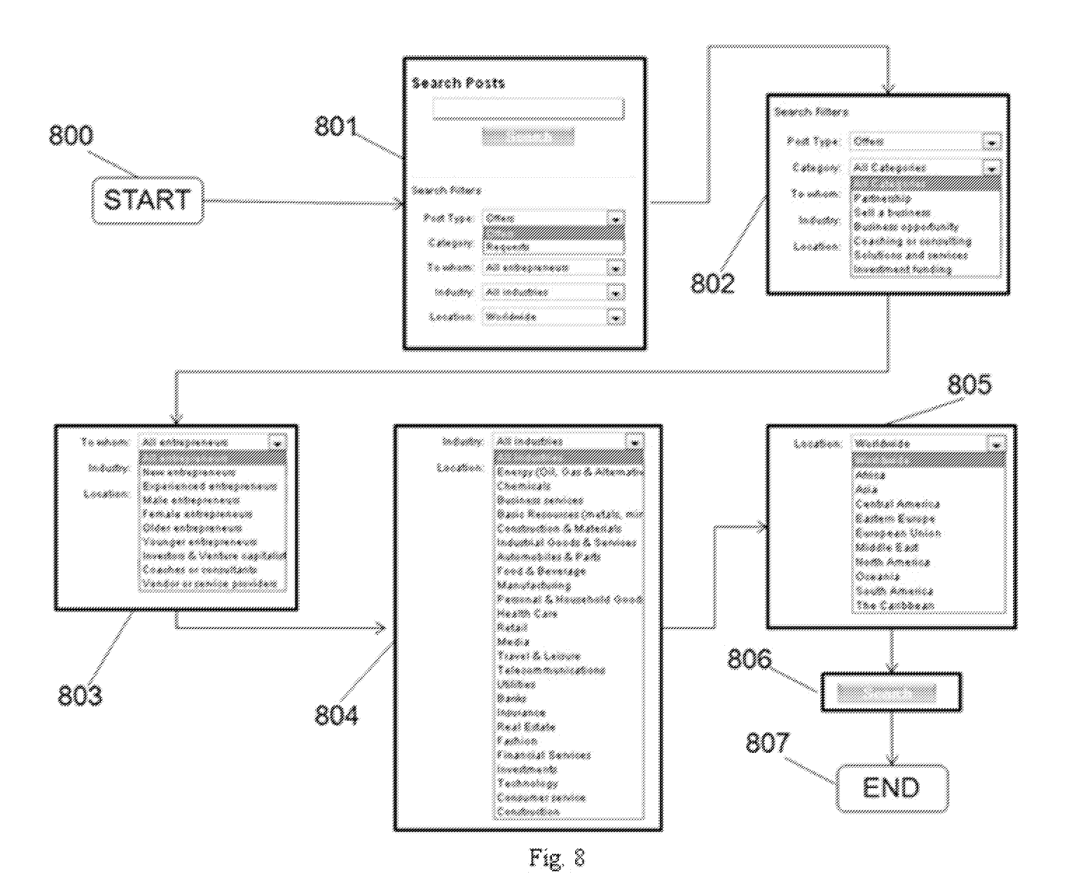

Turning now to FIG. 8, in accordance with an exemplary embodiment of the present invention, a “search filter function” process is described. This process could be provided to one or more members using the application server 103, through their computing devices at any given time.

The method starts at step 800 by a member when they click on SEARCH POSTS icon on the CONNECTIONS tab of the webpage. Instead of scrolling or sorting as previously described in FIG. 7, the member can chose to search the posts.

At step 801, the member may type any key word related to the type of post they are searching for or further define the search by selecting either Offers or Requests.

At step 802, an additional filter could be applied to the categories section, further defining the search. If none is selected the defaulted “ALL” is applied to the search.

At step 803, an additional filter could be applied by selecting to whom the post is intended for, further defining the search. If none is selected the defaulted “ALL” is applied to the search.

At step 804, an additional filter could be applied by selecting the industry the post is intended for, further defining the search. If none is selected the defaulted “ALL” is applied to the search.

At step 805, an additional filter could be applied by selecting the location the post is intended for, further defining the search. If none is selected the defaulted “ALL” is applied to the search.

At step 806, the member may click on Search and the application server 103 searches all the stored posts to find the ones matching the criteria selected and displaying them to the right in the same sortable format explained in FIG. 7. The aforementioned process described in FIG. 8 is but one exemplary embodiment of the systems and methods in accordance with the present invention. One of ordinary skill in the art would appreciate any number or type of filters may be utilized in performing a search, and embodiments of the present invention are contemplated for use with any number and type of filters.

At step 807, the process ends. A new search could start again at described in step 800. In addition to manual searches performed by members, the application server 103 may be set to run predefined searches based on one or more selected criteria at any given interval. Results returned from the predefined searches may be sent or displayed to the member in numerous formats or manners (e.g., via e-mail, facsimile, SMS, phone call).

Turning now to FIG. 9, in accordance with an exemplary embodiment of the present invention, an example of the Request Proposal, page previously mentioned in FIG. 7, is shown. Upon finding an offer of interest in a post search section, a member may click on Request while on the search page or the Request Proposal button found within the detail page of the offer in question. In either case, the result is the appearance of the Request Proposal page shown in FIG. 9, where the member may describe what they are requesting, add links to other websites that are relevant in understanding the Request for a Proposal, and even upload files to the attachment feature. Once the Request is completed, the member clicks on Send and the party responsible for the offer post is notified. The aforementioned form described in FIG. 9 is but one exemplary embodiment of the systems and methods in accordance with the present invention. One of ordinary skill in the art would appreciate any number or type of forms may be utilized in accordance with embodiments of the present invention, and embodiments of the present invention are contemplated for use with any number and type of forms.

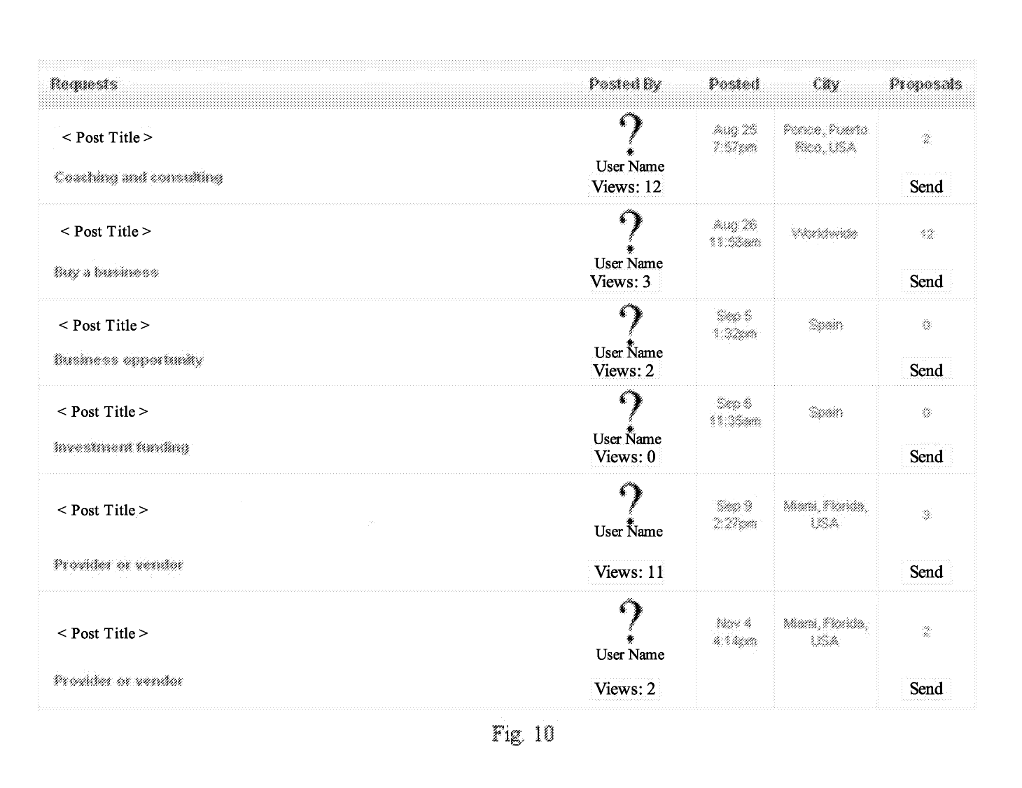

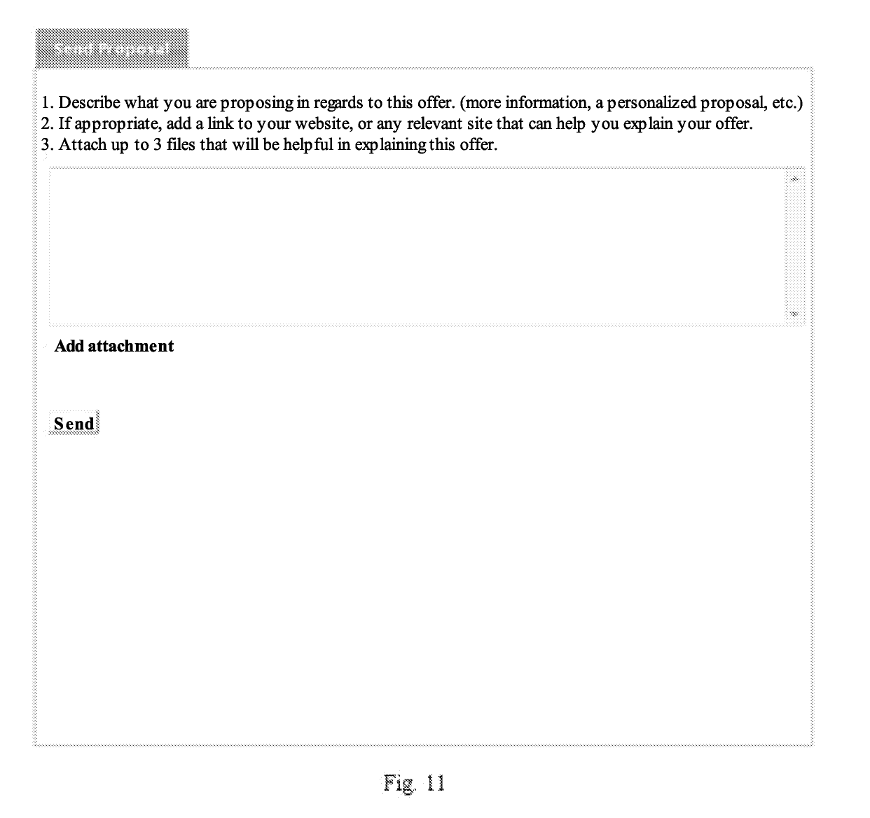

Turning now to FIG. 10, in accordance with an exemplary embodiment of the present invention, an example of the search engine showing requests, sorted by posted date and time, is shown. A member may scroll and see all the postings showing the Request, clicking on any of them to see the detail information, or sort the posts by alphabetically by title, name of a member that created the Request, date and time posted, intended location, and how many proposals each post has received. The member may also click on the Send button to be taken to a page where a Proposal could be sent, as further explained in FIG. 11.

Turning now to FIG. 11, in accordance with an exemplary embodiment of the present invention, an example of the Send Proposal page, briefly mentioned in FIG. 10, is shown. Upon finding a an request of interest in the post search section, a member may click on Send while on the search page or the Send Proposal button found within the detail page of the Request in question. In either case, the result is the appearance of the Send Proposal page, where the member may describe what they are proposing, add links to other websites that are relevant in understanding their proposal, and even upload files to the attach feature. Once the Proposal is completed, the member may click on Send and the party responsible for the Request post is notified. The aforementioned form described in FIG. 11 is but one exemplary embodiment of the systems and methods in accordance with the present invention. One of ordinary skill in the art would appreciate any number or type of forms may be utilized in accordance with embodiments of the present invention, and embodiments of the present invention are contemplated for use with any number and type of forms.

Turning now to FIG. 12, in accordance with an exemplary embodiment of the present invention, an example of the Proposal Folder that becomes available to a first member when a second member sends them a proposal based on request posted the first member. The folder appears to the first member in the “My Proposals” section of the site. The first member can review the attached files and read the full description of the Proposal received. The first member may also Decline the Proposal or Add the second member as a Connection and accept the Proposal. If the later occurs, then the meeting room becomes activated as further explained in FIG. 14.

Turning now to FIG. 13, in accordance with an exemplary embodiment of the present invention, an example of the Proposal Request Folder that becomes available to a first member when a second member sends the first member a Proposal Request from an offer posted by the first member is shown. The folder appears to the first member in the “My Proposals” section of the site. The first member may review any attached files and read a full description of the Proposal Request. The first member may also Decline the Proposal Request or Accept the Proposal Request and add as a Connection the second member. If the later occurs, then a meeting room becomes activated as further explained in FIG. 14. The first member may now use the meeting room to send the Requested Proposal using a messaging system and file upload tools found in the meeting room.

Turning now to FIG. 14, in accordance with an exemplary embodiment of the present invention, an example of the Meeting Room Tab 1400 that becomes available to a first member when the first member adds a Proposal or Proposal Request as a Connection. Once activated both the first member and a second member may send each other messages, only viewable though the meeting room, and upload documents that could be reviewed by both the first member and the second member. Each time a file is uploaded or a new message is posted by the first member or the second member, the non-sending member gets notified.

Turning now to FIG. 15, in accordance with an exemplary embodiment of the present invention, an example of the Agreements Tab that becomes available to a first member when the first member accepts a Proposal or Proposal Request and adds a second member as a Connection is shown. Once activated both the first member and the second member may upload documents that could be reviewed by both the first member and the second member. In addition, to reaching an agreement, boxes with the first member's name and the second member's name must be checked, signaling an agreement to the terms of the uploaded document by both the first member and the second member, in order to activate a Payment Tab. Each time a file is uploaded or the agreement box is clicked on by the first member or the second member, the other member gets notified.

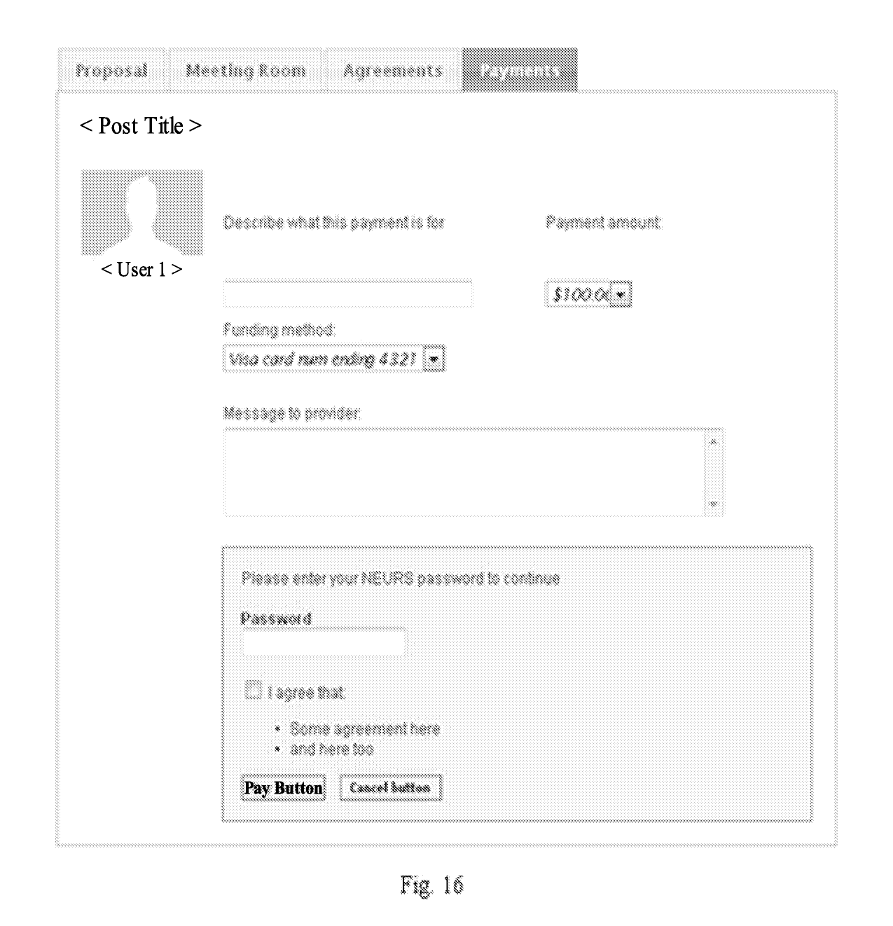

Turning now to FIG. 16, in accordance with an exemplary embodiment of the present invention, an example of the Payment Tab that becomes available to a first member and a second member when they come to a mutual agreement in the Agreement Tab of the folder. Once activated both the first member and the second member may make payments to each other by describing the reason for the payment, selecting an amount from a dropdown box, including the possibility of adding an amount not available in the dropdown box, selecting the card from which to make the payment, and even adding a comment that will be sent to the provider when the payment is transacted. Before the payment may be processed, a paying member must agree to the terms of a payment center and enter a password as stored in the application server 103 and click on the Pay button to generate a transaction. Each time a payment is transacted by either the first member or the second member, the other member gets notified.

Several of the previous exemplary embodiments have dealt with situations between a first member and a second member. One of ordinary skill in the art would appreciate that most, if not all, transactions, systems and methods may be conducted between two or more members of the system without departing from the spirit and scope of the present invention.

According to an embodiment of the present invention, the systems and methods herein described may be further enhanced with the utilization of location based services (LBS). LBS are utilized on computing devices capable of determining a user's location via one or more methods. Methods for determining a user's location include, but are not limited to, global positioning systems (GPS), cellular or other wireless transmission triangulation and internet protocol (IP) address determinations. One of ordinary skill in the art would appreciate that there are numerous ways in which to determine the location of a user of a computing device, and embodiments of the present invention are contemplated for use with any manner of determining the location of a user of a computing device.

According to an embodiment of the present invention, LBS may be utilized by members posting requests of offers to define of limit geographical areas in which they are interested in receiving responses from. In this manner, only members whose computing devices indicate they are in the limited geographic area selected by the posting member may be allowed to post. Conversely, posting members may require responses from members outside of a specific geographic area. For instance, a posting member may desire to only receive responses from members outside an area they were previously limited from taking action in (e.g., contractually limited by a non-competition clause).

According to an embodiment of the present invention, LBS may be utilized by members with a time based geographically limited need. For instance, a posting member may have a need to meet with another member at a specific time and place to receive a specific service. In this manner, the posting member may limit responses to members with computing devices currently active in the geographically limited area or within a certain distance of the geographic area. An example of this is an entrepreneur may have an immediate need for legal review of a hardcopy document. They entrepreneur may post a request for an in person review of the document and limit the geographic area to a small, easy commutable area. In this example, only other members with computing devices currently active in the geographic area defined by the posting member would be able to send a proposal.

In another embodiment, members may tag areas, using their computing device, they frequent or they travel to on occasion. In this manner, if a posting member is looking for someone with knowledge of or access to a specific area, that knowledge or access could verified or verified in part through the use of LBS. According to an embodiment of the present invention, the tagging member may be required to use a computing device LBS confirmation method that indicates specific location (e.g., GPS) as opposed to generalized location (e.g., IP address).

In another embodiment of the present invention, one or more members may let their computing devices with LBS let other members in a surrounding geographic area know that they are available for a networking opportunity. A networking opportunity may be any in person or other meeting between two or more members. For instance, a member in a new city on business may let other members know that they are in the new city and looking for a lunch date. Any other member in the area may make a request to meet the posting member for the lunch date.

According to an embodiment of the present invention, the system and methods herein may allow for two or more members who have made an agreement through the methods and systems provided herein to locate each other and meet. This may be achieved through the use of computing devices with LBS enabled. For instance, three members who have finalized an agreement may decide to meet at a first member's office to begin their project. The first member may tag his office and the address of the office may appear to the other two member, for instance, in a shared project workroom. The other two members may use their LBS enabled computing devices to find their way to the tagged address. Directions may be provided, for instance, via the LBS enabled computing device.

According to an embodiment of the present invention, LBS may be utilized to notify active members of new posts in their vicinity. In this manner, when a new offer or request post becomes available that is looking for proposals from members in a specific geographically limited area, members in that geographically limited area may receive an alert if their LBS enabled computing device is active and confirms their appropriately located. Members may be alerted in any number of ways, including, but not limited to, SMS, Email, Phone Call or instant messaging. One of ordinary skill in the art would appreciate that there are numerous ways a member could be alerted to geographically specific opportunities, and embodiments of the present invention are contemplated for use with any manner of alerts.

According to another embodiment of the present invention, any of the previous systems and methods herein described may be utilized with LBS enabled computing devices to enhance the access and awareness of members. Any system or method previously described herein may be further enhanced through the use of LBS enabled computing devices.

Furthermore, while multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for facilitating connections between entrepreneurs, said method comprising:
receiving, at an application server, an offer post from a first entrepreneur;
sending, from said application server, said offer post to a second entrepreneur,
wherein the second entrepreneur has one or more characteristics identified by said first entrepreneur in said offer post;
receiving, at said application server, from said second entrepreneur, a request post referencing said offer post,
wherein said request post is comprised of data points relevant to said offer post;
providing, from said application server, to said first entrepreneur, said request post; and
receiving, at said application server, a response from said first entrepreneur related to said request post.

2. The method of claim 1, further comprising the steps of:
providing, from said application server, a meeting room,
wherein said first entrepreneur and said second entrepreneur may enter said meeting room; and
providing, from said application server, one or more tools for reaching an agreement to said first entrepreneur and said second entrepreneur.

3. The method of claim 1, wherein said data points are comprised of objective information.

4. The method of claim 1, wherein said data points are comprised of subjective information.

5. The method of claim 1, wherein said set of one or more characteristics are comprised of objective information.

6. The method of claim 1, wherein said set of one or more characteristics are comprised of subjective information.

7. The method of claim 1, wherein at least one of said one or more characteristics of said second entrepreneur identified by said first entrepreneur in said offer post is a location based characteristic.

8. The method of claim 7, wherein said location based characteristic is confirmed by a location based services enabled computing device operated by said second entrepreneur.

9. A method for facilitating connections between entrepreneurs, said method comprising:
receiving, at an application server, a request post from a first entrepreneur;
sending, from said application server, said request post to a second entrepreneur,
wherein the second entrepreneur has one or more characteristics identified by said first entrepreneur in said request post;
receiving, at said application server, from said second entrepreneur, an offer post referencing said request post,
wherein said offer post is comprised of data points relevant to said request post;
providing, from said application server, to said first entrepreneur, said offer post; and
receiving, at said application server, a response from said first entrepreneur related to said offer post.

10. The method of claim 9, further comprising the steps of:
providing, from said application server, a meeting room,
wherein said first entrepreneur and said second entrepreneur may enter said meeting room; and
providing, from said application server, one or more tools for reaching an agreement to said first entrepreneur and said second entrepreneur.

11. The method of claim 9, wherein said data points are comprised of objective information.

12. The method of claim 9, wherein said data points are comprised of subjective information.

13. The method of claim 9, wherein said set of one or more characteristics are comprised of objective information.

14. The method of claim 9, wherein said set of one or more characteristics are comprised of subjective information.

15. The method of claim 9, wherein at least one of said one or more characteristics of said second entrepreneur identified by said first entrepreneur in said offer post is a location based characteristic.

16. The method of claim 15, wherein said location based characteristic is confirmed by a location based services enabled computing device operated by said second entrepreneur.

17. A method for facilitating connections between entrepreneurs, said method comprising:
receiving, at an application server, a post search request from a first entrepreneur,
wherein said post search request is meant to identify one or more posts from one or more posting entrepreneurs based on one or more data points;
sending, from said application server, a set of identified posts resulting from said post search request from said first entrepreneur,
wherein said set of identified posts is comprised of a plurality of data points; and
receiving, at said application server, one or more posts from said first entrepreneur,
wherein said one or more posts relate to said set of identified posts.

18. The method of claim 17, further comprising the steps of:
providing, from said application server, a meeting room,
wherein said first entrepreneur and said one or more posting entrepreneurs may enter said meeting room; and
providing, from said application server, one or more tools for reaching an agreement to said first entrepreneur and said one or more posting entrepreneurs.

19. The method of claim 17, wherein said one or more data points are comprised of objective information.

20. The method of claim 17, wherein said one or more data points are comprised of subjective information.

21. The method of claim 17, wherein said plurality of data points are comprised of objective information.

22. The method of claim 17, wherein said plurality of data points are comprised of subjective information.

23. The method of claim 17, wherein at least one of said one or more data points of said search request is a location based data point.

24. The method of claim 23, wherein said location based characteristic is confirmed by a location based services enabled computing device operated by said first entrepreneur.
